(19) United States
(12) Patent Application Publication
(10) Pub. No.: US 2024/0215782 A1
(43) Pub. Date: Jul. 4, 2024

(54) Blasting System Cleaning Assembly and Method of Use

(71) Applicant: Benjamin LeCompte, Houston, TX (US)

(72) Inventor: Benjamin LeCompte, Houston, TX (US)

(21) Appl. No.: 18/544,183

(22) Filed: Dec. 18, 2023

Related U.S. Application Data
(63) Continuation-in-part of application No. 17/119,628, filed on Dec. 11, 2020, now Pat. No. 11,884,480.
Application No. 17/119,628 is a continuation-in-part of application No. 16/736,595, filed on Jan. 7, 2020, now Pat. No. 11,285,580.
Application No. 16/736,595 is a continuation-in-part of application No. 15/812,206, filed on Nov. 14, 2017, now Pat. No. 10,569,386.
Application No. 15/812,206 is a continuation-in-part of application No. 14/848,330, filed on Sep. 8, 2015, now Pat. No. 9,844,851.
Application No. 14/848,330 is a continuation-in-part of application No. 15/712,453, filed on Sep. 22, 2017, now Pat. No. 10,449,657.
Application No. 15/712,453 is a continuation-in-part of application No. 14/848,330, filed on Sep. 8, 2015, now Pat. No. 9,844,851.
Application No. 15/812,206 is a continuation-in-part of application No. 14/773,694, filed on Sep. 8, 2015, now Pat. No. 9,849,560.
(63) Continuation-in-part of application No. 18/335,122, filed on Jun. 14, 2023.
(60) Provisional application No. 62/880,540, filed on Jul. 30, 2019.
(60) Provisional application No. 62/398,225, filed on Sep. 22, 2016.

(51) Int. Cl. A47L 9/16; A47L 9/28

(52) U.S. Cl. CPC A47L 9/1683; A47L 9/2857

(57) ABSTRACT

A blasting system comprising an air compressor is disclosed. Comprising the air compressor to provide a compressed air. A vacuum assembly operatively connected to the air compressor, wherein the vacuum assembly is configured to receive the compressed air and generate a vacuum in a cleaning nozzle. A debris reservoir connected to the vacuum assembly, wherein the vacuum assembly is configured to use the vacuum to transport debris into the debris reservoir. An adjustable suction control within the vacuum assembly to regulate the vacuum strength for debris extraction.

### CROSS-REFERENCE TO RELATED APPLICATIONS

This application is a Continuation-In-Part of U.S. Non-Provisional patent application Ser. No. 17/119,628, filed on Jan. 7, 2020, which is a Continuation-In-Part of U.S. Non-Provisional patent application Ser. No. 16/736,595, filed on Jul. 30, 2019, now expired. The application Ser. No. 16/736,595 claims priority from U.S. Provisional Patent Application No. 62/880,540, filed on Jul. 30, 2019, now expired.

Further, the application Ser. No. 16/736,595 is also a Continuation-In-Part of U.S. Non-Provisional patent application Ser. No. 15/812,206, filed on Nov. 14, 2017. The application Ser. No. 15/812,206 is, in turn, a Continuation-In-Part of both U.S. Non-Provisional patent application Ser. No. 14/848,330, filed on Sep. 8, 2015, and U.S. Non-Provisional patent application Ser. No. 15/712,453, filed on Sep. 22, 2017.

Additionally, the application Ser. No. 15/712,453 claims priority from U.S. Provisional Patent Application No. 62/398,225, filed on Sep. 22, 2016, now expired, and is also a Continuation-In-Part of U.S. Non-Provisional patent application Ser. No. 14/848,330, filed on Sep. 8, 2015.

Moreover, the application Ser. No. 15/812,206 is a Continuation-In-Part of U.S. Non-Provisional patent application Ser. No. 14/773,694, filed on Sep. 8, 2015. The application Ser. No. 14/773,694 is a Continuation-In-Part of PCT Application No. PCT/US14/22170, filed on Mar. 7, 2014.

All of the aforementioned applications, and each of their respective patents, as applicable, are hereby incorporated by reference herein in their entirety.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

The invention, as outlined in the claims, pertains to a blasting system (100) designed to enhance the efficiency and effectiveness of air treatment, particularly in industrial applications. The system is characterized by its innovative components and operational capabilities, which are summarized as follows:

### Blasting System Overview:

The core of the invention is a blasting system (100) that includes an air compressor (326). The air compressor is specifically designed to supply compressed air (302), which is a critical component of the system's functionality.

### Vacuum Assembly Integration:

A key feature of the system is a vacuum assembly (330) that is operatively connected to the air compressor (326). This vacuum assembly is engineered to receive the compressed air (302) from the air compressor and utilize it to generate a vacuum (334) in a cleaning nozzle (336).

The integration of the vacuum assembly with the air compressor represents a significant innovation, enhancing the system's capability to manage and control air flow and pressure.

### Functional and Operational Advantages:

The system's design, particularly the vacuum assembly's ability to generate a vacuum using compressed air, suggests a focus on improving operational efficiency and versatility in industrial settings.

The incorporation of the cleaning nozzle (336) indicates a specific application in environments where precise and efficient cleaning is essential, likely targeting industries where air quality and debris removal are critical concerns.

No prior art is known to the Applicant.

### BRIEF SUMMARY OF THE INVENTION

### Summary of the Invention

The present invention, titled “Blasting System Cleaning Assembly and Method of Use,” is a significant advancement in the field of air treatment systems, especially those designed for industrial applications. It focuses on improving heat dissipation and humidity control of input air used in various industrial equipment, addressing critical concerns in industrial settings where the quality of input air is paramount.

### Background and Objectives:

In industrial environments, equipment sensitive to moisture and particulate contaminants requires high-quality input air. Traditional air treatment systems struggle with managing the cleanliness and humidity of air, particularly in compact setups. This invention addresses these challenges by providing a system capable of delivering clean, dry air at varying pressures suitable for both large and small industrial equipment. The key objectives include ensuring the provision of clean, dry air, offering flexible pressure ranges, replacing traditional desiccant systems with a more efficient and portable solution, incorporating a water reservoir for effective moisture control, and designing a system that is easy to deploy and use in various industrial applications.

### System Components:

The air cleaner system of the invention includes an air dryer assembly, a fan, an air input assembly, a mini flex assembly, a filter assembly, and an air output assembly, all working in tandem to filter input air into a treated air output.

The detailed description includes an embodiment of a blasting system (100) comprising a tank (102), a cart (104) for mobility, a venting cap (105), a pinch cutoff (106), a vibrator (107), a bleed valve (108), and a collar element (111). The tank is detailed with a top end (201a), bottom end (201b), shell (202), cap (204), cone (206), neck (208), top aperture (211), threading (210), and lug nuts (212). The system is designed for seamless operation and ease of mobility.

### Innovative Vacuum Assembly:

A notable feature is the vacuum assembly (330), innovatively designed to receive compressed air (302) from an air compressor (326). This assembly creates a vacuum (334) in a cleaning nozzle (336) and is optimized for maximum efficiency in debris suction, capable of handling a wide range of debris types and sizes. The vacuum assembly incorporates adjustable suction control for customization based on specific cleaning requirements. The design ensures seamless integration with the blasting system, maintaining compactness and portability while enhancing functionality. The associated debris reservoir (338) is designed for easy detachment and cleaning, facilitating quick maintenance and minimizing downtime in industrial settings.

In summary, the invention presents a comprehensive solution for air treatment in industrial applications, focusing on delivering clean, dry air, enhancing operational efficiency, and ensuring ease of use and maintenance.

### BRIEF DESCRIPTION OF THE SEVERAL VIEWS OF THE DRAWING

FIGS. 1A and 1B illustrate a perspective first side and second side overview of a blasting system 100, and a flow diagram.

FIGS. 2A, 2B and 2C illustrate an elevated side view, top view and bottom view of said tank 102.

FIG. 3 illustrates a flow chart 300 of a compressed air 302 through said blasting system 100.

FIG. 4 illustrates a method of use 400 of said blasting system 100 with said vacuum assembly 330.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

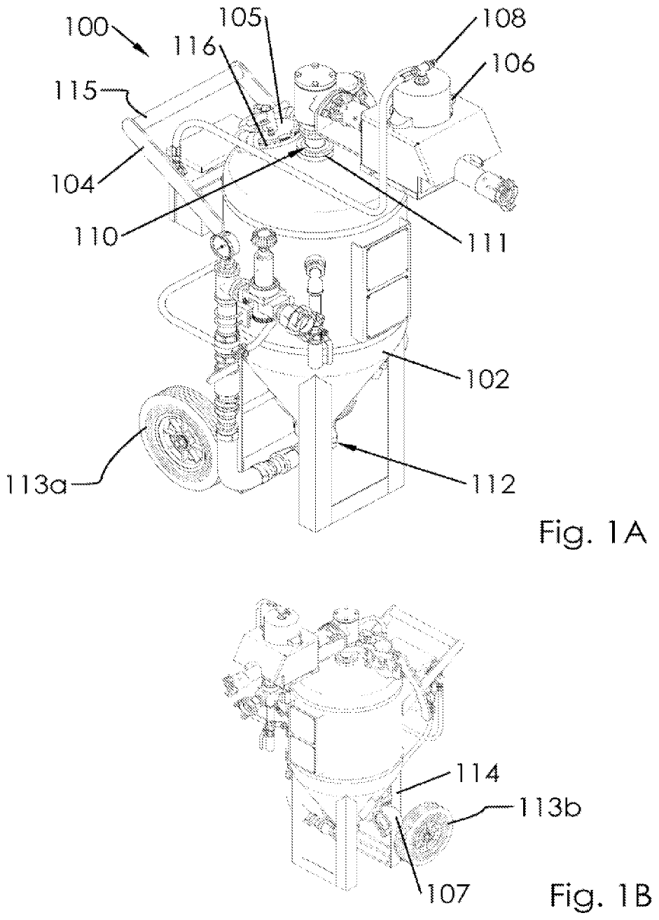

FIGS. 1A and 1B illustrate a perspective first side and second side overview of a blasting system 100, and a flow diagram.

In one embodiment, said blasting system 100 can comprise a tank 102, a cart 104, a venting cap 105, a pinch cutoff 106, a vibrator 107, a bleed valve 108, and a collar element 111. In one embodiment, said tank 102 can comprise an outlet 110, an inlet 112, and a bracket 114. In one embodiment, said cart 104 can attach to a portion of said tank 102 for easy mobility.

In one embodiment, said cart 104 can comprise two wheels 113 (comprising a first wheel 113a and a second wheel 113b) attached to said bracket 114; wherein, said bracket 114 attaches to said tank 102 and said two wheels 113 allow said blasting system 100 to roll. Said cart 104 can comprise a handle 115.

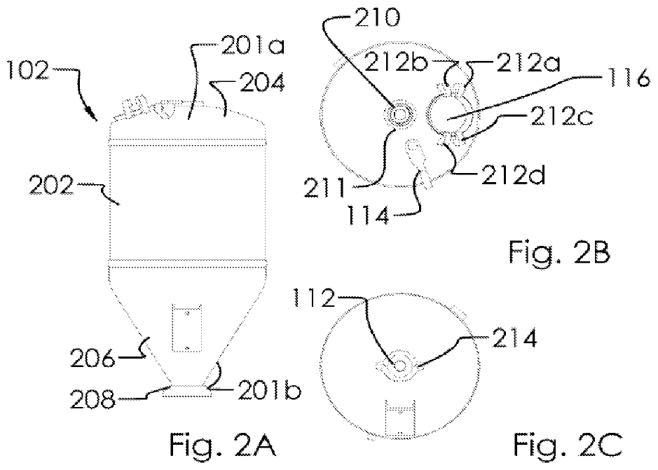

FIGS. 2A, 2B and 2C illustrate an elevated side view, top view and bottom view of said tank 102.

In one embodiment, said tank 102 can comprise a top end 201a, a bottom end 201b, a shell 202, a cap 204, a cone 206, a neck 208, a top aperture 211, a threading 210 and one or more lug nuts 212. In one embodiment, said one or more lug nuts 212 can comprise a first lug nut 212a, a second lug nut 212b, a third lug nut 212c, and a fourth lug nut 212d. In one embodiment, a bracket 214 can fasten to said threading 210. In one embodiment, said collar element 111 can attach to said threading 210 of said outlet 110. In one embodiment, a tank air hose 318c can attach to said inlet 112 at said bracket 214.

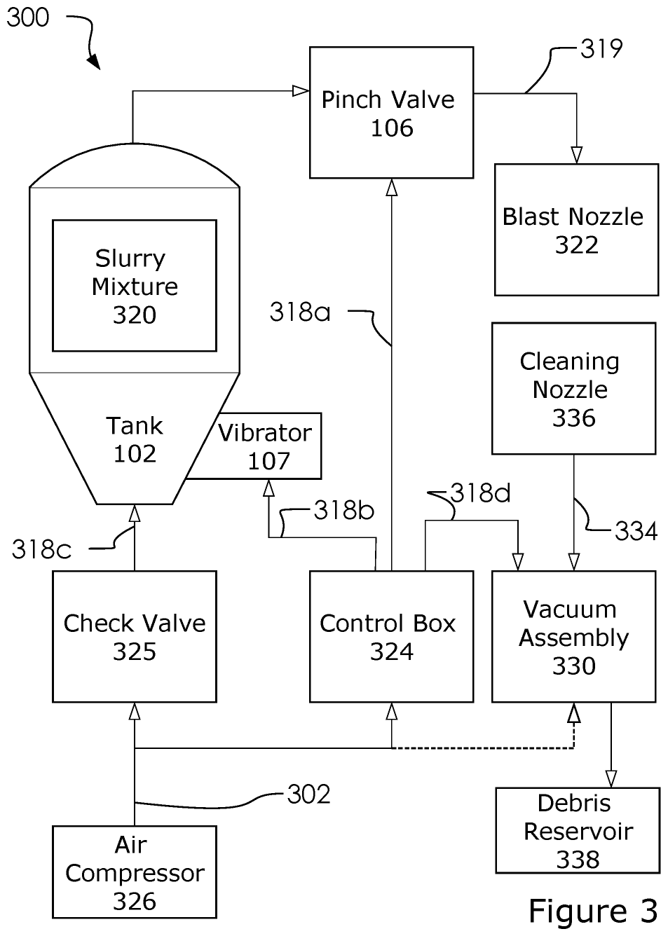

FIG. 3 illustrates a flow chart 300 of a compressed air 302 through said blasting system 100.

In one embodiment, one or more air hoses 318 can connect an air compressor 326 to said tank 102, said vibrator 107, said pinch cutoff 106 and a vacuum assembly 330. In one embodiment, said compressed air 302 can comprise a pinch air hose 318a, a vibrator air hose 318b, said tank air hose 318c and a vacuum assembly air hose 332. in one embodiment, a portion of said one or more air hoses 318 can be controlled using a control box 324 which can be installed between said air compressor 326 and a portion of said one or more air hoses 318. For example, said control box 324 can control a volume and pressure of said compressed air 302 directed into each among said one or more air hoses 318.

In one embodiment, said compressed air 302 from said air compressor 326 can be connected to said vacuum assembly 330 directly and in another embodiment, said vacuum assembly 330 can receive air through said control box 324.

In one embodiment, said vacuum assembly 330 can receive said compressed air 302 from said air compressor 326 and can create a relative air pressure to create a vacuum 334 in a cleaning nozzle 336. Further, said vacuum assembly 330 can be configured to use said vacuum 334 to pull a debris into a debris reservoir 338.

As discussed in the parent applications to this filing, said pinch air hose 318a can attach to said pinch cutoff 106. In one embodiment, said vibrator air hose 318b can attach to said vibrator 107. In one embodiment, said tank air hose 318c can attach to said inlet 112. In one embodiment, said vibrator 107 can create a vibrating force against said tank 102 to keep a slurry mixture 320 moving through said tank 102. In one embodiment, said blasting system 100 can comprise a blasting hose 319. In one embodiment, said blasting hose 319 can deliver a blasting fluid out of said blasting system 100.

In one embodiment, said blasting system 100, can comprise a blast nozzle 322, said control box 324, a check valve 325 and said air compressor 326. In one embodiment, a compressed air can pass from said air compressor 326 into said control box 324 and on to a remaining portion of said blasting system 100. In one embodiment, said control box 324, can transfer said compressed air 302 to said tank 102, said vibrator 107, and/or to said pinch cutoff 106, as discussed above. In one embodiment, said check valve 325 can be placed between said tank 102 and said control box 324. In one embodiment, said check valve 325 can ensure that said compressed air 302 from said control box 324 and said air compressor 326 do not send too much air pressure into said tank 102. In one embodiment, said compressed air 302 can mix with said slurry mixture 320 within said tank 102, passing through said pinch cutoff 106, and out of said blast nozzle 322.

In one embodiment, said vibrator 107 can maintain a viscosity of said slurry mixture 320 by vibrating said tank 102. In one embodiment, said vibrator 107 can be caused to shake by supplying a compressed air to said vibrator 107. In one embodiment, said pinch cutoff 106 can close a fluid passage within said blasting hose 319, between said tank 102 and said blast nozzle 322.

In one embodiment, said vacuum assembly 330 is innovatively designed to receive said compressed air 302 from said air compressor 326. This configuration enables said vacuum assembly 330 to generate a relative air pressure, effectively creating said vacuum 334 in said cleaning nozzle 336. The design of said vacuum assembly 330 is optimized for maximum efficiency in debris suction, ensuring a robust and continuous operation even under varying air pressure conditions.

Notably, said vacuum assembly 330 is engineered to utilize said vacuum 334 for the effective extraction of debris. The assembly includes a specialized suction mechanism that enhances the debris collection process, drawing particulates and contaminants into said debris reservoir 338 with high efficiency. This feature is particularly advantageous in environments where quick and thorough cleaning is essential.

Furthermore, said vacuum assembly 330 incorporates advanced features such as an adjustable suction control, allowing for customization of the vacuum strength based on the specific requirements of the cleaning task. This adjustability ensures that said vacuum assembly 330 can handle a wide range of debris types and sizes, from fine dust to larger particles.

The integration of said vacuum assembly 330 with the broader blasting system is seamlessly executed, maintaining the compactness and portability of the overall system while enhancing its functionality. The design of said vacuum assembly 330 complements the existing components of the blasting system, ensuring that the addition of this feature does not impede the system's ease of use or effectiveness.

Moreover, said debris reservoir 338, associated with said vacuum assembly 330, is meticulously designed for easy detachment and cleaning. This aspect of the design facilitates quick maintenance and ensures that the system can be rapidly returned to operation after debris disposal, thereby minimizing downtime in industrial settings.

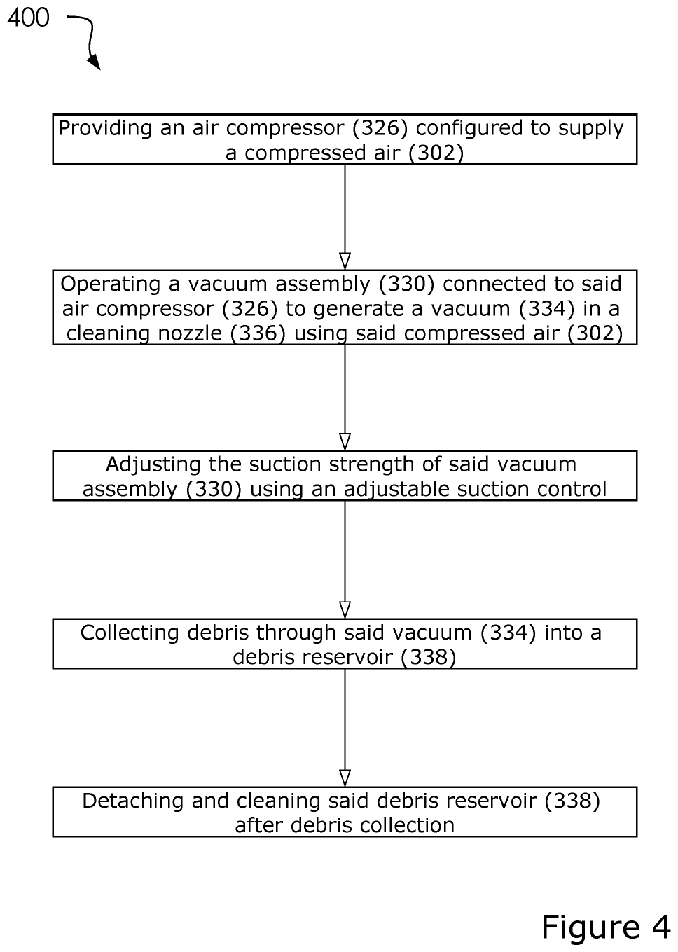

FIG. 4 illustrates a method of use 400 of said blasting system 100 with said vacuum assembly 330.

### PREFERRED EMBODIMENT

The preferred embodiment of said blasting system 100 with said vacuum assembly 330 is summarized in the original claims and further presented as follows.

Said blasting system 100 comprising said air compressor 326 can comprise said air compressor 326 configured to provide said compressed air 302. Said vacuum assembly 330 operatively connected to said air compressor 326, wherein said vacuum assembly 330 can be configured to receive said compressed air 302 and generate said vacuum 334 in said cleaning nozzle 336. Said debris reservoir 338 connected to said vacuum assembly 330, wherein said vacuum assembly 330 can be configured to use said vacuum 334 to transport debris into said debris reservoir 338. An adjustable suction control within said vacuum assembly 330 to regulate the vacuum strength for debris extraction.

Said blasting system 100 comprising said air compressor 326 can comprise said air compressor 326 configured to provide said compressed air 302. Said vacuum assembly 330 operatively connected to said air compressor 326, wherein said vacuum assembly 330 can be configured to receive said compressed air 302 and generate said vacuum 334 in said cleaning nozzle 336. Said debris reservoir 338 connected to said vacuum assembly 330, wherein said vacuum assembly 330 can be configured to use said vacuum 334 to transport debris into said debris reservoir 338. An adjustable suction control within said vacuum assembly 330 to regulate the vacuum strength for debris extraction.

Said vacuum assembly 330 includes a specialized suction mechanism designed to enhance debris collection efficiency.

Said debris reservoir 338 can be detachable and designed for ease of cleaning and maintenance.

A configuration that maintains system compactness and portability despite the integration of said vacuum assembly 330.

Said vacuum assembly 330 operates continuously under varying air pressure conditions provided by said air compressor 326.

Said method of use 400 of said blasting system 100 with said air compressor 326, the method can comprise providing said air compressor 326 configured to supply said compressed air 302. Operating said vacuum assembly 330 connected to said air compressor 326 to generate said vacuum 334 in said cleaning nozzle 336 using said compressed air 302. Adjusting the suction strength of said vacuum assembly 330 using an adjustable suction control. Collecting debris through said vacuum 334 into said debris reservoir 338. Detaching and cleaning said debris reservoir 338 after debris collection.

Enhancing debris collection efficiency using a specialized suction mechanism within said vacuum assembly 330.

The step of collecting debris includes transporting a range of debris sizes from fine dust to larger particles.

Maintaining continuous operation of said vacuum assembly 330 under varying air pressure conditions provided by said air compressor 326.

### PARTS LIST

Said blasting system 100,
said tank 102,
said cart 104,
said venting cap 105,
said pinch cutoff 106,
said vibrator 107,
said bleed valve 108,
said collar element 111,
said outlet 110,
said inlet 112,
said bracket 114,
said two wheels 113,
said first wheel 113a,
said second wheel 113b,
said handle 115,
said top end 201a,
said bottom end 201b,
said shell 202,
said cap 204,
said cone 206,
said neck 208,
said top aperture 211,
said threading 210,
said one or more lug nuts 212,
said first lug nut 212a,
said second lug nut 212b,
said third lug nut 212c,
said fourth lug nut 212d,
said bracket 214,
said flow chart 300,
said compressed air 302,
said one or more air hoses 318,
said air compressor 326,
said vacuum assembly 330,
said pinch air hose 318a,
said vibrator air hose 318b,
said tank air hose 318c,
said blasting hose 319,
said blast nozzle 322,
said control box 324,
said check valve 325,
said slurry mixture 320,
said vacuum assembly air hose 332,
said vacuum 334,
said cleaning nozzle 336, and
said debris reservoir 338.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A blasting system comprising an air compressor comprising:
said air compressor configured to provide a compressed air;
a vacuum assembly operatively connected to said air compressor, wherein said vacuum assembly is configured to receive said compressed air and generate a vacuum in a cleaning nozzle;
a debris reservoir connected to said vacuum assembly, wherein said vacuum assembly is configured to use said vacuum to transport debris into said debris reservoir; and
an adjustable suction control within said vacuum assembly to regulate the vacuum strength for debris extraction.

2. The blasting system of claim 1, wherein:
said vacuum assembly includes a specialized suction mechanism designed to enhance debris collection efficiency.

3. The blasting system of claim 1, wherein:
said debris reservoir is detachable and designed for ease of cleaning and maintenance.

4. The blasting system of claim 1, wherein:
a configuration that maintains system compactness and portability despite the integration of said vacuum assembly.

5. The blasting system of claim 1, wherein:
said vacuum assembly operates continuously under varying air pressure conditions provided by said air compressor.

6. A method of use of a blasting system with an air compressor, the method comprising:
providing said air compressor configured to supply a compressed air;
operating a vacuum assembly connected to said air compressor to generate a vacuum in a cleaning nozzle using said compressed air;
adjusting the suction strength of said vacuum assembly using an adjustable suction control;
collecting debris through said vacuum into a debris reservoir; and
detaching and cleaning said debris reservoir after debris collection.

7. The method of use of claim 6, further comprising enhancing debris collection efficiency using a specialized suction mechanism within said vacuum assembly.

8. The method of use of claim 6, wherein
the step of collecting debris includes transporting a range of debris sizes from fine dust to larger particles.

9. The method of use of claim 6, further comprising maintaining continuous operation of said vacuum assembly under varying air pressure conditions provided by said air compressor.

10. The method of use of claim 6, wherein
the system retains compactness and portability despite the integration of said vacuum assembly.

11. A blasting system comprising an air compressor comprising:
said air compressor configured to provide a compressed air;
a vacuum assembly operatively connected to said air compressor, wherein said vacuum assembly is configured to receive said compressed air and generate a vacuum in a cleaning nozzle;
a debris reservoir connected to said vacuum assembly, wherein said vacuum assembly is configured to use said vacuum to transport debris into said debris reservoir;
an adjustable suction control within said vacuum assembly to regulate the vacuum strength for debris extraction; and
said vacuum assembly includes a specialized suction mechanism designed to enhance debris collection efficiency.
